(19) United States
(12) Patent Application Publication
(10) Pub. No.: US 2016/0124227 A1
(43) Pub. Date: May 5, 2016

(54) SYSTEM AND METHOD FOR MOUNTING HEADS-UP DISPLAY MODULES

(71) Applicants: Hai Yong Zhang, San Jose, CA (US); Wenfeng Zhang, San Jose, CA (US); Chenchen Zheng, San Jose, CA (US); Peng Shao, San Jose, CA (US); Jia Chi Wu, San Jose, CA (US); Jia Ning Zhao, Fremont, CA (US); David Pommerenke, Rolla, MO (US)

(72) Inventors: Hai Yong Zhang, San Jose, CA (US); Wenfeng Zhang, San Jose, CA (US); Chenchen Zheng, San Jose, CA (US); Peng Shao, San Jose, CA (US); Jia Chi Wu, San Jose, CA (US); Jia Ning Zhao, Fremont, CA (US); David Pommerenke, Rolla, MO (US)

(21) Appl. No.: 14/530,660

(22) Filed: Oct. 31, 2014

(51) Int. Cl. G02B 27/01

(52) U.S. Cl. CPC G02B 27/0149; G02B 27/0176; G02B 2027/0169; G02B 2027/0198

(57) ABSTRACT

A device comprising means for engaging said device to at least a portion of an outside surface of a glass of a headwear, means for engaging said device to at least a portion of an inside surface of glass of said headwear, means for mounting a display module or video capturing device and said means for engaging said device to at least a portion of an inside surface of a headwear to said device, and means for adjusting a viewing angle of said display module or video capturing device with a generally 360 degrees rotation.

### FEDERALLY SPONSORED RESEARCH OR DEVELOPMENT

The present Utility patent application claims priority benefit of the U.S. provisional application for patent Ser. No. 61/899,212 “A System and Method for Mounting Heads-Up Display Modules”. filed on 2013, Nov. 2, under 35 U.S.C. 119(e). The contents of this related provisional application are incorporated herein by reference for all purposes to the extent that such subject matter is not inconsistent herewith or limiting hereof.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the present invention relate generally to mounting devices. More particularly, one or more embodiments of the invention relate to a system and method for mounting heads-up display modules.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. It is believed that heads-up display modules may be useful in a variety of applications such as, but not limited to, driving a motorcycle or scooter, skiing, golfing, driving an all-terrain vehicle, hunting, sport shooting, etc. Furthermore, one may expect that a user who desires to use a heads-up display may need to buy specialized goggles or a helmet comprising a heads-up display module. By way of educational background, an aspect of the prior art generally useful to be aware of is that many currently available heads-up display module systems are typically not universally compatible with all goggles and helmets.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a side perspective exploded view of an exemplary mounting device, in accordance with an embodiment of the present invention;

FIG. 2 is a side perspective view of an exemplary mounting device in use inside a motorcycle helmet, in accordance with an embodiment of the present invention;

FIG. 3 is a side perspective view of an exemplary mounting device in use inside a snow goggle, in accordance with an embodiment of the present invention; and

FIGS. 4A and 4B illustrate an exemplary mounting device for a heads-up display, in accordance with an embodiment of the present invention. FIG. 4A is a diagrammatic side view of the mounting device, and FIG. 4B is a diagrammatic side view of the inner portion of the mounting device.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

One embodiment of the present invention may provide a system and method for mounting heads-up display modules or audio/video capturing devices inside goggles or helmets. Some embodiments may allow for universal mounting of devices to virtually any type, style, or brand of goggles and helmets. Furthermore, some embodiments may enable the viewing angle of a heads-up display module to be adjusted 360 degrees.

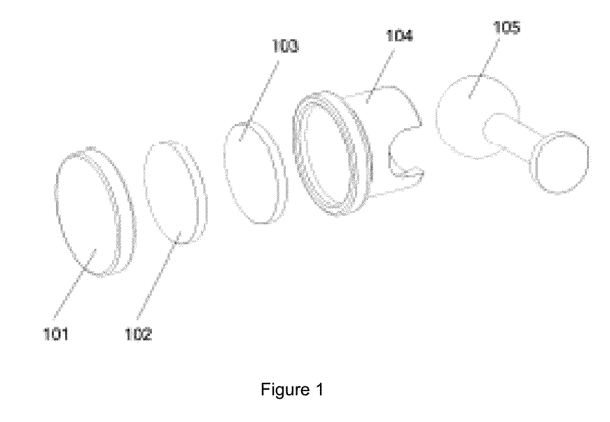

FIG. 1 is a side perspective exploded view of an exemplary mounting device, in accordance with an embodiment of the present invention. In the present embodiment, an outer housing 101 may be implemented to hold a strong magnet 102, which may be placed on the outside of a goggle lens or the glass of a helmet. An inner housing 104 may hold another strong magnet 103 and may be fixed to a heads-up display module or an audio/video recording device by a shaft 105. Magnets 102 and 103 are typically able to attract each other and may hold the entire module on a surface placed between magnets 102 and 103. It is contemplated that a multiplicity of suitable types of magnets may be used in some embodiments of the present invention including, without limitation, electromagnets, rare earth magnets, magnets made of various different ferromagnetic materials such as, but not limited to, iron, nickel, cobalt, some alloys or composites, some minerals, etc. Housings 101 and 104 may be made of a multiplicity of suitable materials including, without limitation, various different metals or plastics.

In the present embodiment, shaft 105 comprises a ball at one end and a mounting platform for a heads-up display module at the opposite end. The ball of shaft 105 may be placed inside inner housing 104 so that the ball is held within housing 104 yet the ball may be rotated freely, which may enable shaft 105 to achieve an optimized viewing angle of an attached object for the user. In some embodiments the viewing angle can be adjusted 360 degrees. Those skilled in the art will readily recognize, in light of and in accordance with the teachings of the present invention, that a multiplicity of suitable devices may be attached to the mounting device such as, but not limited to, heads-up display modules, audio and/or video recording devices, cameras, display screens, etc. Moreover, various different means may be used to attach these devices to the mounting platform including, without limitation, threaded connectors, clamps, adhesives, suction mounts, hook and loop material, etc. In the present embodiment, the use of strong magnets 102 and 103 may enable a user to attach the mounting device to virtually any type of goggles or helmets for the mounting of heads-up display modules, video capturing devices, or other such devices. Furthermore, the use of magnets 102 and 103 is typically a non-invasive means of mounting that may enable a device to be attached to an object with no permanent alterations to the object. It is contemplated that mounting devices in accordance with some embodiments of the present invention may be used to mount devices to objects other than goggles and helmets such as, but not limited to, glasses or sunglasses.

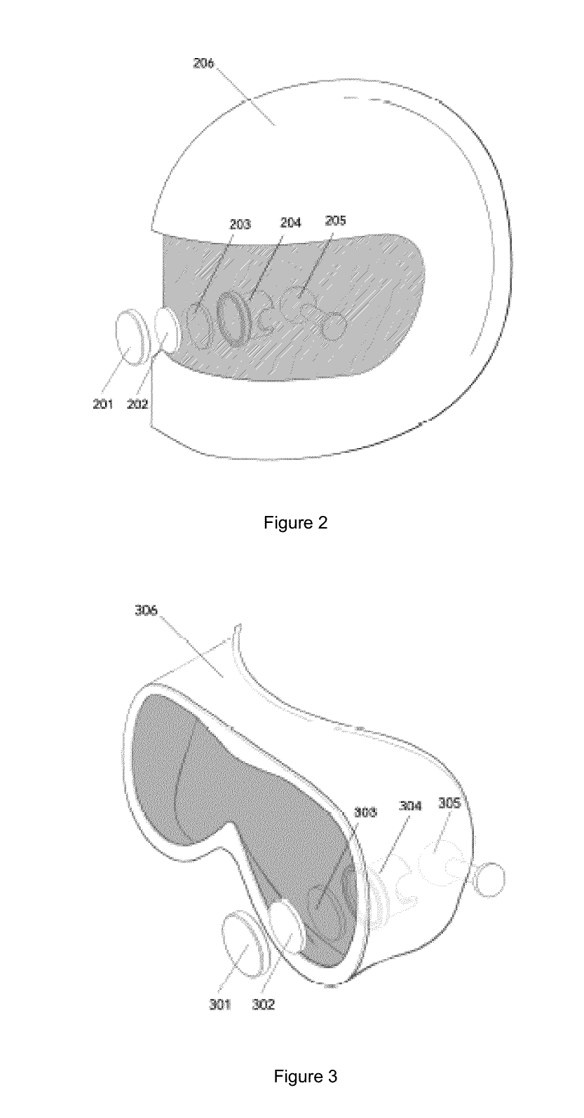

FIG. 2 is a side perspective view of an exemplary mounting device in use inside a motorcycle helmet 206, in accordance with an embodiment of the present invention. In typical use of the present embodiment, a magnet 202 within an outer housing 201 may be placed on the outside of the glass of helmet 206 and a magnet 203 within an inner housing 204 comprising a shaft 205 may be placed on the inside of the glass of helmet 206 in alignment with magnet 202. The magnetic field created between magnets 202 and 203 is typically strong enough to hold the mounting device and various devices that may be attached to the mounting device in place.

FIG. 3 is a side perspective view of an exemplary mounting device in use inside a pair of snow goggles 306, in accordance with an embodiment of the present invention. In the present embodiment the mounting device is attached to goggles 306 in a similar manner as that shown by way of example in FIG. 2. An outer housing 301 comprising a magnet 302 is placed on the outside of the lens of goggles 306, and an inner housing 304 comprising a magnet 303 and a shaft 305 is attached on the inside of the lens of goggles 306. Housings 301 and 304 are held in place by the magnetic field of magnets 302 and 303.

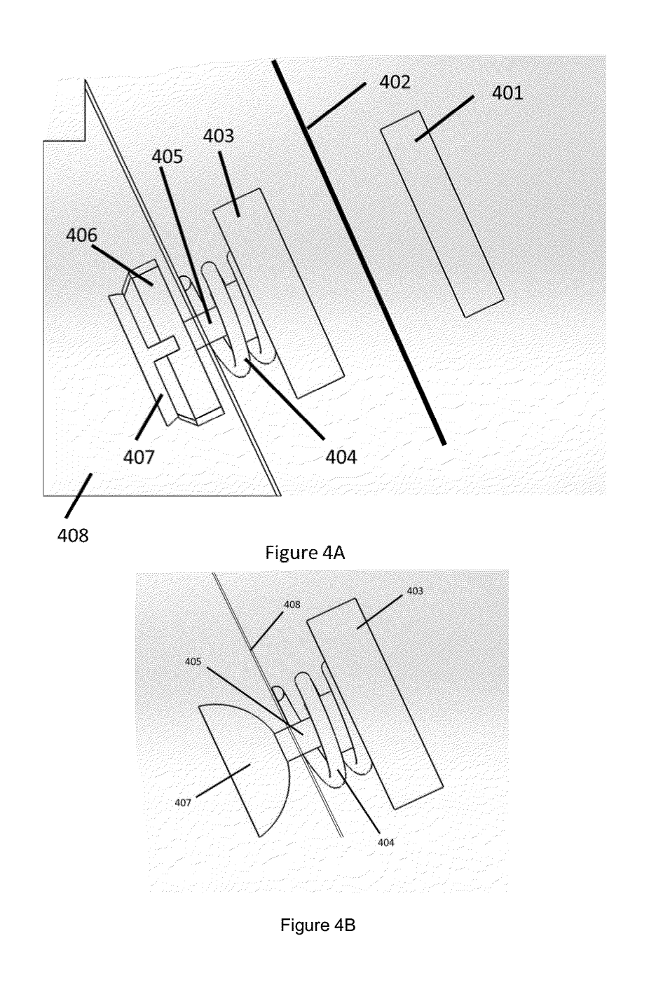

FIGS. 4A and 4B illustrate an exemplary mounting device for a heads-up display, in accordance with an embodiment of the present invention. FIG. 4A is a diagrammatic side view of the mounting device, and FIG. 4B is a diagrammatic side view of the inner portion of the mounting device. In the present embodiment, a housing 401 holds a strong magnet and is typically placed on the outside of a goggle or helmet glass 402. An inner housing 403 may hold another strong magnet and may be fixed to a case 408 of an attached object such as, but not limited to, a heads-up display module. These two magnets may create a magnetic force to attract each other and hold housings 401 and 403 along with case 408 onto glass 402. A shaft 405 connects housing 403 to a stopper 407. Housing 403, shaft 405, and stopper 407 may be fixed together and made in metal or another material of suitable strength to support the weight of case 408. A spring 404 may be placed around shaft 405 between housing 403 and case 408. A collar 406 may be fixed to case 408 around stopper 407. Case 408, being part of the display module, has a hole for which the shaft goes through. Stopper 407 is inside the case.

In typical use of the present embodiment, the attraction between magnets within housings 401 and 403 affixes the device and case 408 onto glass 402. In addition, adjustment means on housing 403 may enable case 408 to rotate 360 degrees to generally achieve an optimized viewing angle for the user. In order to adjust the viewing angle, spring 404 may be compressed so that case 408 and collar 406 move towards glass 402 and away from stopper 407. This typically enables case 408 to be rotated so that the angle of case 408 may be changed. When spring 404 is released, collar 406 returns to its original position around stopper 407. Referring to FIG. 4A, stopper 407 comprises a hemispherical shape that fits snugly within collar 406 to hold case 408 in place in the chosen viewing angle. In some embodiments the stopper and/or the collar may have a coating of a pliant material such as, but not limited to, rubber or silicone to provide added grip between the stopper and the collar to hold the case in the desired position. It is contemplated that a multiplicity of suitable adjustment means may be used in some alternate embodiments to allow for the adjusting of the viewing angle of an attached object. For example, without limitation, some embodiments may comprise hinged adjustment means, a ball joint at the inner housing, etc.

Those skilled in the art will readily recognize, in light of and in accordance with the teachings of the present invention, that some embodiments may comprise various different features such as, but not limited to, magnet housings with decorative shapes or colors, stopping points along the path of adjustment, coatings on the magnets or housings to generally prevent scratches on the glass to which the device is mounted, etc. In some embodiments, the parts of the mounting device may be made available separately. For example without limitation, in some embodiments the adjustment means may be built into the object to be mounted while the magnetic mounting means may be offered separately.

All the features disclosed in this specification, including any accompanying drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of implementing a system and method for mounting heads-up display modules or audio/video capturing devices according to the present invention will be apparent to those skilled in the art. Various aspects of the invention have been described above by way of illustration, and the specific embodiments disclosed are not intended to limit the invention to the particular forms disclosed. The particular implementation of the mounting system and method may vary depending upon the particular context or application. By way of example, and not limitation, the mounting systems and methods described in the foregoing were principally directed to helmet or goggle mounted implementations; however, similar techniques may instead be applied to mounting systems for other types of objects such as, but not limited to, eyeglasses, sunglasses, windows, windshields for automobiles, motorcycles, scooters, boats, recreational vehicles, all-terrain vehicles, golf carts, etc., which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

What is claimed is:

1. A device comprising:
an outer housing;
a first magnet, wherein said first magnet being configured to be in at least partial engagement with at least a portion of said outer housing;
an inner housing comprising at least a first end portion and a second end portion;
a second magnet, said second magnet being in at least a partial engagement with said first end portion of said inner housing, wherein said second magnet is configured to at least enable a substantial magnetic attraction with said first magnet;
a shaft, said shaft comprising a ball at a distal end portion of said shaft and a mounting platform at an opposite distal end portion of said shaft, wherein said ball being configured to be in engagement with said second end portion of said inner housing, in which said shaft is further configured to be capable of rotation within said inner housing;

2. The device of claim 1, wherein said first magnet and said second magnet being configured to at least enable a substantial magnetic engagement of said device with at least a portion of a goggle or helmet.

3. The device of claim 2, wherein at least a portion of said mounting platform is configured to be substantially engaged with at least a display module or a video capturing device.

4. The device of claim 3, wherein said helmet is at least a motorcycle helmet.

5. The device of claim 4, wherein said outer housing along with said first magnet are generally located outwardly and proximal to an outside surface portion of a glass of said motorcycle helmet, in which said inner housing along with said second magnet and said shaft are generally located inwardly and proximal to an inside surface portion of said glass of said motorcycle helmet, said second magnet is substantially in alignment with said first magnet to at least enable a substantial magnetic hold of said device in a predetermined location of said glass surface of said motorcycle helmet.

6. The device of claim 3, wherein said goggles is at least a pair of snow goggles.

7. The device of claim 6, wherein said outer housing along with said first magnet are generally located outwardly and proximal to an outside surface portion of a lens of said pair of snow goggles, in which said inner housing along with said second magnet and said shaft are generally located inwardly and proximal to an inside surface portion of said lens of said pair of snow goggles, said second magnet is substantially in alignment with said first magnet to at least enable a substantial magnetic hold of said device in a predetermined location of said lens of said pair of snow goggles.

8. The device of claim 3, wherein said display module is at least a heads-up display.

9. The device of claim 1, wherein said first magnet and said second magnet being configured to at least enable a substantial magnetic engagement of said device to a portion of a glass surface.

10. The device of claim 2, wherein said first magnet and said second magnet being configured to at least enable a substantial magnetic engagement of said device to a lens or glass portion of a goggle or helmet with at least no alteration of said goggle or helmet.

11. The device of claim 9, wherein said mounting platform comprising at least a stopper.

12. The device of claim 11, further comprising at least a spring generally placed around said shaft.

13. The device of claim 12, further comprising at least a collar, said collar being configured to be in engagement with said stopper, wherein said mounting platform is further being configured to be in engagement with a case of at least a display module or video capturing device, in which said case comprise a hole in which said shaft goes through.

14. The device of claim 13, wherein said spring being configured to substantially compress to generally move said case and said collar towards said glass and away from said stopper for substantially adjusting a viewing angle of said display module or video capturing device, said viewing angle being enabled with a generally 360 degrees rotation.

15. The device of claim 14, wherein said case is configured to be in engagement with a predetermined viewing angle by releasing said spring.

16. A device comprising:
means for engaging said device to at least a portion of an outside surface of a glass of a headwear;
means for engaging said device to at least a portion of an inside surface of a glass of said headwear;
means for mounting a display module or video capturing device and said means for engaging said device to at least a portion of an inside surface of a headwear to said device;
means for adjusting a viewing angle of said display module or video capturing device, said viewing angle being enabled with a generally 360 degrees rotation;

17. A device comprising:
an outer housing;
a first magnet, said first magnet is into engagement with at least a portion of said outer housing;
an inner housing comprising at least a first end portion and a second end portion;
a second magnet, said second magnet is into engagement with said first end portion of said inner housing, wherein said second magnet is configured to at least enable a substantial magnetic attraction with said first magnet;
a shaft, said shaft comprising a ball at a distal end of said shaft and a mounting platform at an opposite distal end portion of said shaft, wherein said ball is configured to be in engagement with at least a portion of said second end portion of said inner housing;
wherein said first magnet and said second magnet is configured to at least enable a magnetic engagement of said device to at least a portion of a lens surface of a goggle or a portion of a glass surface of a helmet;
wherein at least a portion of said mounting platform is configured to substantially engage at least a heads-up display module or video capturing device, and wherein said shaft is further configured to be capable of at least a 360 degrees rotation to adjust a viewing angle of said heads-up display module or video capturing device.

18. The device of claim 17, wherein said helmet is at least a motorcycle helmet.

19. The device of claim 17, wherein said goggles is at least a pair of snow goggles.

20. The device of claim 18, wherein said outer housing along with said first magnet are generally located outwardly and proximal to an outside surface portion of a glass of said motorcycle helmet, in which said inner housing along with said second magnet and said shaft are generally located outwardly and proximal to an inside surface portion of said glass of said motorcycle helmet, said second magnet is substantially in alignment with said first magnet to at least enable a substantial magnetic engagement of said device in a predetermined location of said glass surface of said motorcycle helmet.
